(19) United States
(12) Patent Application Publication
(10) Pub. No.: US 2026/0040343 A1
(43) Pub. Date: Feb. 5, 2026

(54) SYSTEM AND METHOD FOR ELECTRONIC LABELS, ELECTRONIC LABELS, AND GATEWAY DEVICES

(71) Applicant: M2Communication Inc., Zhube (TW)

(72) Inventor: Derrick Wei, Zhubei (TW)

(73) Assignee: M2Communication Inc., Zhube (TW)

(21) Appl. No.: 19/283,465

(22) Filed: Jul. 29, 2025

(30) Foreign Application Priority Data
Jul. 30, 2024 (TW) 113128262
Sep. 11, 2024 (TW) 113134518

(51) Int. Cl. H04W 72/542; H04W 72/0446

(52) U.S. Cl. CPC H04W 72/542; H04W 72/0446

(57) ABSTRACT

A gateway device using a wireless transmission channel and an identifier (ID) is disclosed. The gateway device includes a first transceiver module and a first processing module. The first transceiver module is configured to transmit a first wireless signal to and receive an indication from one of an electronic label and a base station. The first processing module is electrically connected to the first transceiver module, and configured to determine whether to communicate with one of the electronic label and the base station on the wireless transmission channel according to the indication, wherein after determining that the first processing module communicates with the electronic label on the wireless transmission channel, the gateway device transmits a time slot schedule to one of the electronic label and the BS.

### CROSS REFERENCE TO RELATED APPLICATIONS

The application claims the benefit of Taiwan Application No. 113128262, filed on Jul. 30, 2024, at the TIPO, the disclosures of which are incorporated herein in their entirety by reference.

### FIELD OF THE INVENTION

The present disclosure is related to a system and method for electronic labels, electronic labels and gateway devices, and particularly to an electronic label, its system and method, and gateway devices that can automatically configure communication configurations.

### BACKGROUND OF THE INVENTION

Electronic labels (E-Label) can be used for product pricing in general stores, material classification and material numbers in warehousing, induction deductions for traffic tolls, induction for access control, attendance records for commuting and work, etc. Electronic labels used in general stores and warehouses usually have display units such as electronic paper to display product information and material information respectively, and these items of information are updated through wireless networks. Electronic labels used for transportation, access control, and attendance usually do not have a display unit, and can often move close to the sensor such as an RFID reader. The sensing distance of the electronic labels used for transportation, access control, and attendance is often just a few centimeters, which is smaller than the meter distance of the electronic labels used in general stores and warehouses, and it belongs to near field communication (NFC). In addition, the transmission rate of the electronic labels used for transportation, access control, and attendance is also smaller than that of the electronic labels used in general stores and warehouses.

The conventional electronic labels used in electronic shelves or storage systems are usually fixed; that is, the information (IT) personnel use a back-end server or handheld device to bind the electronic label to a router that communicates with it in advance. For example, on a wireless IP sharer, the wireless signal of the router can cover the range that can communicate with the electronic label, so the electronic label is usually fixed at the same location. Each router needs to be connected to the backend server or controller through a wired network. When the electronic label is to be changed from one location to another location that cannot be covered by the wireless signal of the original router, the IT personnel need to manually change the binding of the electronic label to another router, so that the other router's signal can cover the new location of the electronic label. In order to avoid signal interference between two routers with the same Service Set Identifier (SSID), the two routers are usually configured so that their signal coverage does not overlap; that is, there will be a dead zone between them to isolate different coverage areas. When the communication configuration of multiple electronic labels requires the IT personnel to manually set one after another, it will increase the burden on the IT personnel. In addition, for general merchants, there are usually no dedicated IT personnel to maintain the system in the background due to cost considerations. In hypermarkets or large enterprises, even if there are dedicated IT personnel at the headquarters, there are many electronic labels and they are widely distributed. Under normal circumstances, these configurations will not be done in branches in various regions, but will be handled by the operating service provider. However, the operation mode of manually binding the electronic label to the router is not only expensive, but also significantly compromises the service efficiencies due to the time lag.

It later evolved that the electronic label can use its own frequency scanning method to automatically search for a router that can communicate with the electronic label when it is disconnected from the original router. Therefore, when the electronic label moves from one area to another area, this method allows the electronic label to choose which router to use. For example, the electronic label can choose a router with stronger signal strength, thereby reducing operating costs as in the manual operation. In this case, in order to eliminate dead zones and allow the coverage areas of different routers to overlap, the routers may use different frequency bands so that the areas do not interfere with each other when they overlap. As a result, not only the frequency bands that the electronic label needs to scan increase, but also when the signals received from different routers are very weak, the electronic label may continue to scan the frequency; both of which will consume a lot of battery energy so that the power that may be used for several years will be exhausted in a short period of time, and the low power consumption requirement of the electronic label cannot be met.

On the other hand, if a single frequency is used to avoid repeated frequency scanning, and multiple routers are configured with different SSIDs, when the electronic label is connected from one router network to another router, the electronic label has to disconnect from the network connection of the original router, and then connect to another router network, causing the transmission data in the connection to be interrupted, and the transmission data has to be retransmitted. In addition, when the signal coverage areas of multiple routers overlap, the signals from different routers at the same time will also overlap, and interfere with the electronic label, causing signal demodulation problems, resulting in slow transmission rates or disconnections, and even the settings of the network cannot be reset. This adds to the workload and inconvenience of the IT staff maintaining the system.

### SUMMARY OF THE INVENTION

Therefore, in view of the above-mentioned deficiencies, the present disclosure proposes an electronic label that can automatically configure communication configurations, a method for the electronic label, and a gateway device. The core of this disclosure lies in the hybrid model of the one-tier network and the two-tier network.

In traditional electronic label networks, there is a one-tier network between the base station (BS) and the label, and the base station is connected to the backend server via an Ethernet network. Therefore, when the capacity of the wireless network is reached (for example, 4000 labels), a second base station needs to be added, which also needs to be connected to the backend server. In order to achieve ideal control, most of these base stations need to be connected to a central controller (i.e. Appliance) to manage the data flow and commands from the server, so that the label can be correctly connected to the designated base station. However, because the two base station networks are completely independent, there will be many problems pointed out above, such as dealing with dead zones, movement, overlap, interference, etc. between wireless networks, which also makes the construction and deployment, and even the background resetting, very complicated.

The unique network architecture of the present disclosure converts the traditional one-tier network into a two-tier network so that the network capacity and range under a single channel can be greatly increased (for example, 4 times), which is suitable for electronic label applications. However, due to the changeable topology of application scenarios, the two-tier network cost is higher since it is more complicated to install in small and medium-sized fields. Therefore, the present disclosure combines the AP (Access Point as Appliance) and the BS1 into one (that is, the Gateway). The use of the network is converted into a one-tier network, which is easy to install and maintain. However, when the application needs to expand the existing capacity or coverage (for example, more than 4000 labels), the user needs to add BS2, BS3, . . . , because the network core already has an AP for coordination, so new base stations can be added directly, using a single frequency, and the areas can overlap without any worries. This solves the contradiction when multiple traditional one-tier networks coexist. The new base station is also connected to the Gateway wirelessly. There is no need to rewire (to the backend server or repeater), thereby achieving automatic settings, and greatly reducing maintenance costs. This is also the most important key to this disclosure.

In an embodiment of the present disclosure, a communication system that applies time-division multiplexing to an electronic label is provided. The communication system includes the electronic label and multiple base stations (BS). The multiple BSs have the same service identification ID, such as the Service Set Identifier (SSID), and the signal coverage areas of different BSs can overlap. The electronic label can use its manufacturing identification code as its own identification code, because generally speaking, the manufacturing identification code is a unique identification code, and there will be no identification code that is the same as the manufacturing identification code, so it can be used for binding. For example, when the electronic label is handshaking with the multiple BSs, the subsequent communication configuration will be automatically configured only when the service identification code listened to at the time is verified and approved by the backend software. The electronic label listens to or receives signals from different BSs at different periods of time to determine which BS the electronic label should connect to for data transmission. The factors that determine the connection may depend on the communication quality related parameters of the electronic label, such as the Received Signal Strength Indication (RSSI).

In an embodiment of the present disclosure, the communication system of the present disclosure that applies the TDMA (Time-Division Multiple Access) to an electronic label includes an access point (AP), and the AP can use time-sharing multiplexing to coordinate the communication connections between the multiple BSs and the electronic label by the wireless network. The AP is connected to the backend server through the Ethernet wired-network or high-speed wireless network (for example, the 5G or WIFI network). The multiple BSs and the electronic label use the same communication channel, such as the same communication frequency or frequency band, and the electronic label can select the optimal BS having a better signal to send and receive data on the same communication frequency or frequency band. The communication frequency can be a relatively low frequency, such as 900 MHz, which has a wider signal coverage than that of the 2.4 GHz or 5.8 GHz frequency used by general wireless sharing devices, such as a maximum radius of 25 meters. Moreover, the communication signals at this relatively low frequency are not likely to interfere with the signals in these relatively high frequency bands. The AP and the multiple BSs can use relatively high frequency or the same relatively low frequency signal to communicate. Before using the communication system of the present disclosure, the software having a specific communication protocol needs to be installed on the electronic label, the multiple BSs, and the AP. For example, the specific communication protocol has a Time-Division Multiple Access (TDMA) at the bottom layer or the physical layer of the communication protocol. After the electronic label determines which BS it is communicating with, the BS connected to the electronic label can send a signal with a slot scheduling. The electronic label can receive the signal, and send and receive data on the same communication channel according to the assigned slot scheduling. In this embodiment, the electronic label can automatically bind its own identification code to the service identification code of the BS to be connected to complete automatic configuration of communication configuration, without the need for IT personnel to set it manually in the background. The electronic labels, AP, and BS all have the function of wireless or wired communication to transmit and receive control signals or data between each other. The BS can be a router, the AP can be a device connected to an Internet Service Provider (ISP), and the electronic label can be a device connected to the Internet through the AP and/or BS.

When installing or configuring the communication system of the present disclosure, an AP is required to coordinate the multiple BSs, so one AP and one BS are required at the least to operate. However, traditionally only one router is required in small stores or small warehouse systems. Therefore, the cost of installing two devices, the AP and BS, is considered to be higher than that of a traditional communication system, which reduces the willingness to install the disclosed system. Therefore, in an embodiment of the present disclosure, the AP and a first BS can be integrated into a Gateway device. Because the gateway device itself includes APs that can coordinate different BSs, it can not only be used as a single BS, but also may serve as a gateway to coordinate the first BS and a second BS. Under this architecture, this single gateway device can communicate directly with the electronic label to form one-tier network architecture, or communicate through the second BS to form two-tier network architecture, to increase the network capacity or extend the network coverage. The hardware cost of this single gateway device is not much different from that of a single BS; it is mainly the non-material cost of software. This non-material cost will not be passed on to small merchant or small warehouse owners. In addition, because the communication system disclosed in this disclosure uses a relatively low-frequency band that is different from the commonly used, it is not easily interfered by the relatively high-frequency band that is commonly used, and the relatively low-frequency band has the advantage of having the wider signal coverage than those of the traditional ones. Therefore, the small merchant or small warehouse owners can accept the performance and price, and the related technology disclosed in this disclosure has more competitive advantages than the traditional electronic labels.

In an embodiment of the present disclosure, the electronic label, the second BS, and the gateway device all transmit and receive data on the same communication channel. The gateway device can directly communicate with the electronic label and transmit/receive data, or indirectly communicate with the electronic label through the second BS and transmit/receive data. The electronic label receives signals from the gateway device and the second BS at different time periods, and compares the relevant parameters of the communication quality of the gateway with those of the second BS, so as to determine whether the electronic label and the gateway device transmit/receive data on the same communication channel, or the electronic label and the second BS transmit/receive data on the same communication channel.

In an embodiment of the present disclosure, since the electronic label must meet low power consumption requirements, transmitting data under a relatively high-bandwidth communication protocol will consume relatively large power consumption, such as a wi-fi communication protocol, which has a non-hopping frequency and the characteristics of continuous fixed bandwidth, e.g. the 100 Mbps level bandwidth. In contrast, the electronic label uses relatively low-bandwidth communication protocols, such as bandwidths below 1 Mbps, so that it will consume relatively low power when transmitting data. When the electronic label transmits data, it can combine the TDMA, the fixed relatively low frequency, or the frequency-hopping Bluetooth low energy (BLE), combined with relatively low-bandwidth transmission channels, so that it consumes less power and avoids signal interference.

In accordance with one aspect of the present disclosure, a system for an electronic label is disclosed. The system for the electronic label comprises a first base station (BS), a second BS, an access point (AP) and at least one electronic label. The first base station (BS) has an identifier (ID) and a first wireless transmission channel, and transmits a first wireless signal having a first signal strength and effective in a first area. The second BS has the ID and the first wireless transmission channel, and transmits a second wireless signal having a second signal strength and effective in a second area. The access point (AP) has a second wireless transmission channel configured to conduct a communication with the first BS and the second BS and allocate time slot schedules for the communication with the first BS and the second BS. The at least one electronic label is configured in at least one of the first area and the second area, wherein the at least one electronic label conducts transmissions on the first wireless transmission channel according to the time slot schedules; and when the at least one electronic label moves between the first area and the second area, the at least one electronic label is configured to determine whether the at least one electronic label conducts transmission with the first BS or the second BS on the first wireless transmission channel according to which one of the first signal strength and the second signal strength is stronger.

In accordance with another aspect of the present disclosure, a method for an electronic label is disclosed. The method for the electronic label comprises the following steps: providing at least one electronic label, a first base station (BS), a second BS and an access point (AP), wherein the first BS has an identifier (ID) and a first wireless transmission channel, the first BS transmits a first wireless signal having the first signal strength and effective in a first area, the second BS has the ID and the first wireless transmission channel and transmits a second wireless signal having the second signal strength and effective in a second area, the AP has a second wireless transmission channel to communicate with the first and the second BSs to allocate time slot schedules to the first BS and the second BS, and the at least one electronic label is configured in at least one of the first area and the second area; receiving the first wireless signal from the first BS during a first time period, and receiving the second wireless signal from the second BS during a second time period; determining whether the at least one electronic label conducts transmission with the first BS or the second BS on the first wireless transmission channel according to which one of the first signal strength and the second signal strength is stronger; and receiving a time slot schedule from at least one of the first BS and the second BS, wherein according to the time slot schedule, the at least one electronic label conducts transmission with the first or second BS on the first wireless transmission channel.

In accordance with a further aspect of the present disclosure, a gateway device using a wireless transmission channel and an identifier (ID) is disclosed. The gateway device using the wireless transmission channel and the identifier (ID) comprises a first transceiver module and a first processing module. The first transceiver module is configured to transmit a first wireless signal to and receive an indication from one of electronic labels. The first processing module is electrically connected to the first transceiver module, and configured to determine whether to communicate with one of the electronic labels on the wireless transmission channel according to the indication, wherein after determining that the first processing module communicates with the electronic label on the wireless transmission channel, the gateway device transmits a time slot schedule to one of the electronic label, so that the electronic label transmits a data to the gateway device on the wireless transmission channel according to the time slot schedule.

The above objectives and advantages of the present disclosure will become more readily apparent to those ordinarily skilled in the art after reviewing the following detailed descriptions and accompanying drawings, in which:

### BRIEF DESCRIPTION OF THE DRAWINGS

FIG. 1 is a schematic diagram showing a system for an electronic label according to a preferred embodiment of the present disclosure;

FIG. 2 is a schematic diagram showing a communication system having a gateway device according to a preferred embodiment of the present disclosure;

FIG. 3 is a schematic diagram showing a method for an electronic label according to a preferred embodiment of the present disclosure;

FIG. 4 is a schematic diagram showing an electronic label according to a preferred embodiment of the present disclosure;

FIG. 5 is a schematic diagram showing a gateway device according to a preferred embodiment of the present disclosure;

FIG. 6 is a schematic diagram showing an electronic label according to another preferred embodiment of the present disclosure; and

FIG. 7 is a schematic diagram of using the BLE protocol to transmit data between an electronic label and two base stations according to a preferred embodiment of the present disclosure.

### DETAILED DESCRIPTION OF THE PREFERRED EMBODIMENTS

The present disclosure will now be described more specifically with reference to the following embodiments. It is to be noted that the following descriptions of preferred embodiments of this disclosure are presented herein for the purposes of illustration and description only; they are not intended to be exhaustive or to be limited to the precise form disclosed.

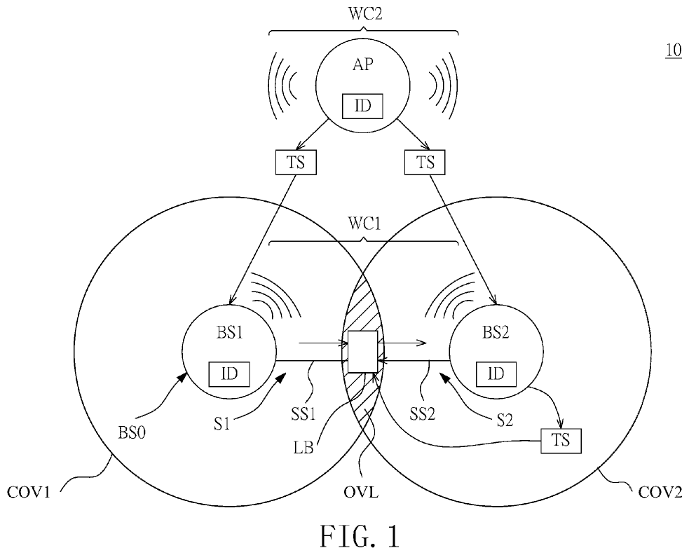

Please refer to FIG. 1, which is a schematic diagram showing a system 10 for an electronic label according to a preferred embodiment of the present disclosure. The system 10 includes a base station (BS) BS1, a base station BS2, an access point AP, and at least one electronic label LB. The base station BS1 has an identifier ID and a wireless transmission channel WC1, and a wireless signal S1 of the base station BS1 covers an area COV1. The base station BS2 has the identifier ID and the wireless transmission channel WC1, and a wireless signal S2 of the base station BS2 covers an area COV2. The access point AP has a wireless transmission channel WC2 to communicate with the base station BS1 and the base station BS2 to allocate a time slot schedule TS to the base station BS1 and the base station BS2. The at least one electronic label LB is configured in at least one of the area COV1 and the area COV2, wherein each electronic label LB transmits/receives data on the wireless transmission channel WC1 according to the time slot schedule TS. When the at least one electronic label LB moves between the area COV1 and the area COV2, the at least one electronic label LB determines whether the at least one electronic label LB should conduct transmission with (e.g. transmit data to/receive data from) the base station BS1 or with the base station BS2 on the wireless transmission channel WC1 based on a signal strength SS1 of the wireless signal S1 and a signal strength SS2 of the wireless signal S2.

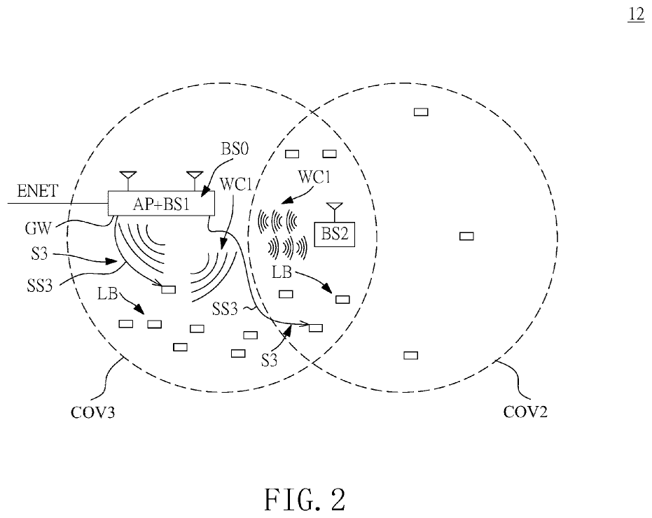

Please refer to FIG. 2, which is a schematic diagram of a communication system 12 having a gateway device according to a preferred embodiment of the present disclosure. Please refer to FIGS. 1 and 2 simultaneously. In FIG. 1, the wireless transmission channel WC1 may be the same as the wireless transmission channel WC2, and the area COV1 and the area COV2 may partially overlap to form an overlapping area OVL. In FIG. 2, the base station BS1 and the access point AP are integrated into a gateway device GW. The gateway device GW has the identifier ID and the wireless transmission channel WC1. A wireless signal S3 of the gateway device GW covers an area COV3. The gateway device GW communicates directly with the at least one electronic label LB in the area COV3, and has a one-tier network architecture. The area COV2 partially overlaps with the area COV3. The gateway device GW communicates indirectly with the at least one electronic label LB in the area COV2 excluded from the area COV3 through the base station BS2, and has a two-tier network architecture. When the at least one electronic label LB moves between the area COV3 and the area COV2, under the condition that a signal strength SS3 of the wireless signal S3 is greater than the signal strength SS2, the at least one electronic label LB conducts transmission with the gateway device GW on the wireless transmission channel WC1. Under the condition that the second signal strength SS2 is greater than the third signal strength SS3, the at least one electronic label LB conducts transmission with the base station BS2 on the wireless transmission channel WC1. The electronic label is an electronic shelf label (ESL). In FIG. 1, when the first signal strength SS1 is greater than the second signal strength SS2, the at least one electronic label LB conducts transmission with the base station BS1 on the wireless transmission channel WC1. When the second signal strength SS2 is greater than the first signal strength SS1, the at least one electronic label LB conducts transmission with the base station BS2 on the wireless transmission channel WC1. When the signal strength SS1 is equal to the signal strength SS2, the at least one electronic label LB maintains transmission with an originally connected base station on the wireless transmission channel WC1.

In any embodiment of the present disclosure, the identifier ID may be a service set identifier (SSID). The base station BS1 and the base station BS2 are a router or a wireless IP sharer. The first area COV1 and the second area COV2 partially overlap. The wireless transmission channel WC1 is a relatively low-frequency wireless transmission channel, and the wireless transmission channel WC2 is a relatively high-frequency wireless transmission channel or a relatively low-frequency wireless transmission channel. An allowable number of the at least one electronic label LB is proportional to a total number of time slots associated with the time slot schedule TS. For example, in an embodiment of the present disclosure, each of the base station BS1 and the base station BS2 has 4000 time slots. Therefore, the base station BS1 and the base station BS2 can manage up to 4000 electronic labels respectively, for a total of 8000 electronic labels. The access point AP can manage up to 4 base stations, so the access point AP or the gateway device GW can manage up to 16,000 electronic labels. The wireless transmission channel WC1 and the wireless transmission channel WC2 are both wireless transmission channels with a fixed non-hopping frequency. The at least one electronic label LB transmits and receives data on a relatively low-frequency wireless transmission channel according to the time slot schedule TS, or transmits and receives data on a frequency-hopping bluetooth low energy (BLE) transmission channel according to the time slot schedule TS. The access point AP in FIG. 1 or the gateway device GW in FIG. 2 can be a wireless sharer connected to the network service provider ISP through a wired Ethernet (ENET) or a wireless mobile 5G, 4G, or 3G network.

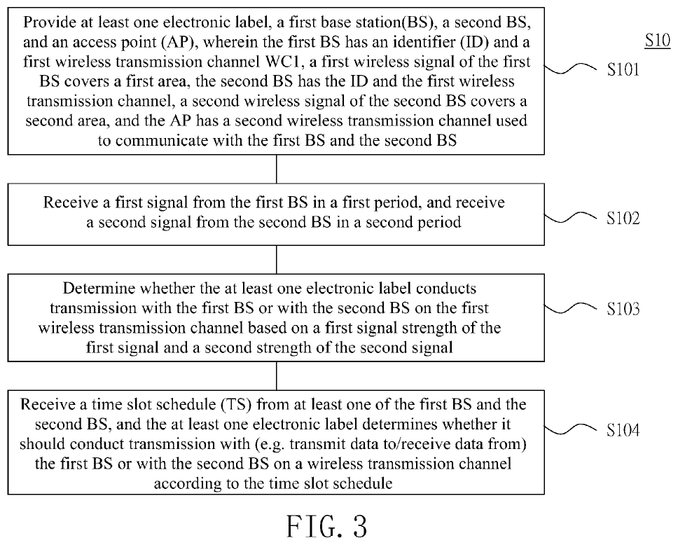

Please refer to FIG. 3, which is a schematic diagram of a method S10 for an electronic label according to a preferred embodiment of the present disclosure. The method S10 includes the following steps. Provide at least one electronic label, a first base station (BS), a second BS, and an access point (AP), wherein the first BS has an identifier (ID) and a first wireless transmission channel WC1, a first wireless signal of the first BS covers a first area, the second BS has the ID and the first wireless transmission channel, a second wireless signal of the second BS covers a second area, and the AP has a second wireless transmission channel used to communicate with the first BS and the second BS (Step S101). The second wireless transmission channel WC2 can be the same as the wireless transmission channel WC1, so that a time slot schedule (TS) is allocated to the first BS and the second BS, and the at least one electronic label is configured in at least one of the first area and the second area. Receive a first signal from the first BS in a first period, and receive a second signal from the second BS in a second period (Step S102). Determine whether the at least one electronic label conducts transmission with the first BS or with the second BS on the first wireless transmission channel based on a first signal strength of the first signal and a second strength of the second signal (Step S103). Receive a time slot schedule (TS) from at least one of the first BS and the second BS, and the at least one electronic label determines whether it should conduct transmission with (e.g. transmit data to/receive data from) the first BS or with the second BS on a wireless transmission channel according to the time slot schedule (Step S104).

In any embodiment of the present disclosure, the first BS and the AP are integrated into a gateway device, the gateway device has the ID and a first wireless transmission channel, and a third wireless signal of the gateway device covers a third area. The gateway device directly communicates with the at least one electronic label in the third area, and has a one-tier network architecture. The second area partially overlaps with the third area. The gateway device communicates indirectly with the at least one electronic label in the second area excluded from the third area through the second BS, and has a two-tier network architecture. The method S10 further includes the following steps. When the at least one electronic label moves between the third area and the second area, under the condition that a third signal strength of the third wireless signal is greater than the second signal strength, the at least one electronic label conducts transmission with the gateway device on the first wireless transmission channel. Under the condition that the second signal strength is greater than the third signal strength, the at least one electronic label conducts transmission with the second BS on the first wireless transmission channel. Under the condition that the third signal strength is equal to the second signal strength, the at least one electronic label maintains transmission with an original BS on the first wireless transmission channel. Both of the third wireless signal and the second wireless signal are a wireless transmission channel with a fixed non-hopping frequency. The at least one electronic label transmits and receives data on a relatively low-frequency wireless transmission channel based on the time slot schedule TS, or transmits and receives data on a frequency-hopping bluetooth low energy (BLE) transmission channel according to the slot schedule TS.

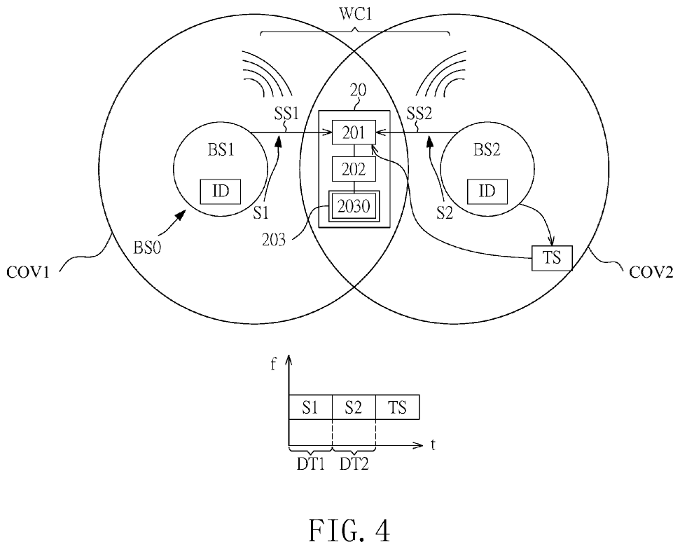

Please refer to FIG. 4, which is a schematic diagram showing an electronic label 20 according to a preferred embodiment of the present disclosure. The electronic label 20, a base station BS1, and a base station BS2 use the same wireless transmission channel WC1. The base station BS1 and the base station BS2 are given the same identifier ID, and the electronic label 20 includes a transceiver module 201 and a processing module 202. The transceiver module 201 receives a signal S1 from the base station BS1 in a first time period DT1, and receives a signal S2 from the base station BS2 in a second time period DT2. The processing module 202 is electrically connected to the transceiver module 201, and determines which of the base station BS1 and the base station BS2 the electronic label 20 should communicate with on the wireless transmission channel WC1 based on a signal strength SS1 of the signal S1 and a signal strength SS2 of the signal S2.

In FIG. 4, the electronic label 20 is an electronic shelf label (ESL). The electronic label 20 further includes an electronic paper (E Paper) 203, which is electrically connected to the processing module 202, and displays the electronic tag information 2030 associated with the electronic label 20. The embodiment in FIG. 4 can be combined with the embodiments in FIGS. 1 and 2 to form another new embodiment. For example, the base station BS1 has a wireless signal S1, the wireless signal S1 covers an area COV1, the base station BS2 has a wireless signal S2, the wireless signal S2 covers an area COV2, and the area COV1 partially overlaps the area COV2. Under the condition that the signal strength SS1 is greater than the signal strength SS2, the processing module 202 controls the electronic label 20 to conduct transmission with the base station BS1 on the wireless transmission channel WC1. When the signal strength SS2 is greater than the signal strength SS1, the processing module 202 controls the electronic label 20 to conduct transmission with the base station BS2 on the wireless transmission channel WC1. When the signal strength SS1 is equal to the signal strength SS2, the processing module 202 controls the electronic label 20 to maintain transmission with an original base station BS0 on the wireless transmission channel WC1. In any embodiment, the gateway device GW has at least one of the wireless transmission channel WC1 and the wireless transmission channel WC2. The wireless transmission channel WC1 and the wireless transmission channel WC2 may be the same, i.e., the WC1 and WC2 are two signal channels, but their frequencies can be the same (for examples, the frequency of WC1=the frequency of WC2 in FIGS. 2, 4, 5, thus only WC1 is shown) or different. The base station BS1 and an access point AP are integrated into a gateway device GW. The gateway device GW has the ID and the wireless transmission channel WC1. A wireless signal S3 of the gateway device GW covers an area COV3. The gateway device GW directly communicates with the electronic label LB in the COV3 area, and has a one-tier network architecture. The area COV2 partially overlaps with the area COV3. The gateway device GW communicates indirectly with the electronic label LB in the area COV2 excluded from the area COV3 through the base station BS2, and has a two-tier network architecture. When the electronic label 20 moves between the area COV3 and the area COV2, under the condition that a signal strength SS3 of the wireless signal S3 is greater than the signal strength SS2, the electronic label 20 conducts transmission with the gateway device GW on the wireless transmission channel WC1. Under the condition that the signal strength SS2 is greater than the signal strength SS3, the electronic label 20 conducts transmission with the base station BS2 on the wireless transmission channel WC1. Both of the wireless transmission channel WC1 and the wireless transmission channel WC2 can be a wireless transmission channel with a fixed non-hopping frequency, and the wireless transmission channel WC2 can be the same as the wireless transmission channel WC1. The electronic label 20 can transmit and receive data on a relatively low-frequency wireless transmission channel according to the time slot schedule TS, or transmit and receive data on a frequency-hopping bluetooth low energy (BLE) transmission channel according to the time slot schedule TS.

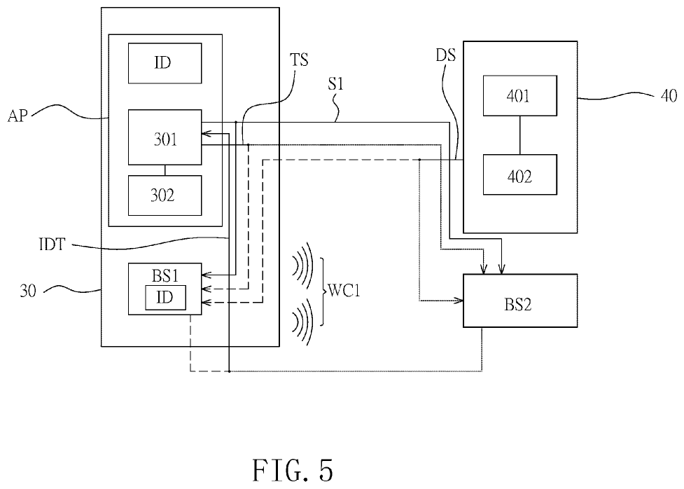

Please refer to FIG. 5, which is a schematic diagram showing a gateway device 30 according to a preferred embodiment of the present disclosure. The gateway device 30 uses a wireless transmission channel WC1 and an identifier ID, and includes a first transceiver module 301 and a first processing module 302. The dash line and dots in FIG. 5 represent that the gateway 30 can selectively transmit and receive data/signal, and the electronic label 40 can also selectively transmit and receive data/signal. The first transceiver module 301 transmits a signal S1 to the base stations BS1, BS2, and receives an instruction IDT. The first processing module 302 is electrically connected to the first transceiver module 301, and determines whether to communicate with the base station BS1 or communicate with the base station BS2 on the wireless transmission channel WC1 according to the indication IDT. After communicating on the wireless transmission channel WC1, the electronic label 40 transmits a time slot schedule TS to the base station BS1 or the base station BS2, so that the electronic label 40 transmits the data DS to the gateway device 30 or the base station BS2 on the wireless transmission channel WC1 according to the time slot schedule TS. When the base station BS1 and the access point AP are integrated into the gateway device 30, and the electronic label 40 and the base station BS1 transmit/receive the data DS, since the gateway device 30 includes the base station BS1, it is equivalent that the electronic label 40 communicates directly with the gateway device 30.

In any embodiment of the present disclosure, the instruction IDT may be an instruction to prepare to transmit data in a time slot. The embodiment in FIG. 5 can be combined with the embodiments in FIGS. 1, 2, and 4 to form another new embodiment. For example, the gateway device GW, 30 includes at least one base station BS1, or includes a base station BS1 and an access point AP. The base station BS1 and the access point AP have the ID and the wireless transmission channel WC1, and the signal S1 of the gateway device GW, 30 covers an area S1. The gateway device GW, 30 communicates directly with the electronic label 20, 40 in the area COV1, and has a one-tier network architecture. The gateway device GW, 30 communicates with a base station BS2 on the wireless transmission channel WC1. A wireless signal S2 of the base station BS2 covers an area COV2. The area COV1 partially overlaps with the area COV2. The gateway device GW, 30 communicates indirectly with the electronic label 20, 40 in the area COV2 excluded from the area COV1 through the base station BS2, and has a two-tier network architecture. The indication IDT of the electronic label 20, 40 is related to a communication quality related parameter between the gateway device GW, 30 and the electronic label 20, 40. The communication quality related parameter includes a received signal strength index RSSI. The electronic label 20, 40 uses the same wireless transmission channel WC1 as the base station BS1 and the base station BS2, and includes a second transceiver module 401 and a second processing module 402. The second transceiver module 401 receives a signal S1 from the base station BS1 in a first time period DT1, and a signal S2 from the base station BS2 in a second time period DT2. The second processing module 402 is electrically connected to the second transceiver module 401, and determines which of the base station BS1 and the base station BS2 the electronic label 20, 40 should communicate with on the wireless transmission channel WC1 according to a signal strength SS1 of the signal S1 and a signal strength SS2 of the signal S2. The electronic label 20, 40 is an electronic shelf label (ESL). The data DS are the data related to the ESL.

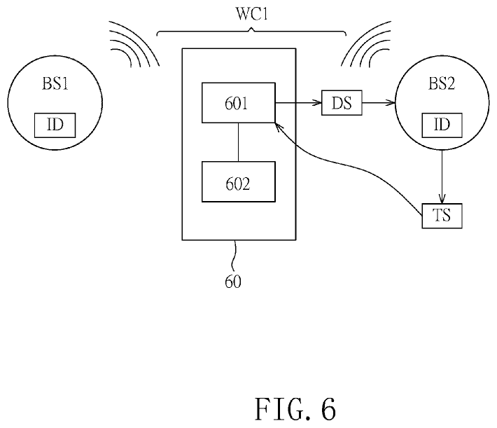

Please refer to FIG. 6, which is a schematic diagram of an electronic label 60 according to another preferred embodiment of the present disclosure. The electronic label 60 uses the same wireless transmission channel WC1 as a base station BS1 and a base station BS2. The base station BS1 and the base station BS2 are given the same identifier ID, and the electronic label 60 includes a transceiver module 601 and a processing module 602. The processing module 602 is electrically connected to the transceiver module 601, and determines which of the base station BS1 and the base station BS2 the electronic label 60 should communicate with on the wireless transmission channel WC1 according to a communication quality-related parameter, wherein the transceiver module 601 receives a time slot schedule TS from the base station BS2 communicating with the electronic label 60. The processing module 602 causes the electronic label 60 and the BS communicating with the electronic label 60 to transmit the data DS on the wireless transmission channel WC1 according to the time slot schedule TS.

The embodiment in FIG. 6 can be combined with the embodiments in FIGS. 1, 2, 4, and 5 to form a new embodiment. For example, the electronic label 60 is an electronic shelf label (ESL). The communication quality related parameter includes a received signal strength index (RSSI). A wireless signal S1 of the base station BS1 covers an area COV1, a wireless signal S2 of the base station BS2 covers an area COV2, and the area COV1 partially overlaps with the area COV2. Under the condition that a signal strength SS1 of the signal S1 is greater than a signal strength SS2 of the signal S2, the electronic label 60 conducts transmission with the base station BS1 on the wireless transmission channel WC1. Under the condition that the signal strength SS2 is greater than the signal strength SS1, the electronic label 60 conducts transmission with the base station BS2 on the wireless transmission channel WC1. When the signal strength SS1 is equal to the signal strength SS2, the electronic label 60 maintains transmission with an original base station BS0 on the wireless transmission channel WC1. The base station BS1 and the base station BS2 communicate with an access point AP on a wireless transmission channel WC2. The wireless transmission channel WC1 and the wireless transmission channel WC2 may be the same. The base station BS1 and the access point AP can be integrated into a gateway device GW, 30. The gateway device GW, 30 has the identifier ID. A wireless signal S3 of the gateway device GW, 30 covers an area COV3. The gateway device GW, 30 communicates directly with the electronic label 20, 40, 60 in the area COV3, and has a one-tier network architecture. The area COV2 partially overlaps with the area COV3. The gateway device GW, 30 communicates indirectly with the electronic label 20, 40, 60 in the area COV2 excluded from the area COV3 through the base station BS2, and has a two-tier network architecture. When the electronic label 40, 60 moves between the area COV3 and the area COV2, under the condition that a signal strength SS3 of the wireless signal S3 is greater than the second signal strength SS3, the electronic label 20, 40, 60 conducts transmission with the gateway device GW, 30 on the wireless transmission channel WC1. Under the condition that the signal strength SS2 is greater than the signal strength SS3, the electronic label 40, 60 conducts transmission with the base station BS2 on the wireless transmission channel WC1. The wireless transmission channel WC1 and the wireless transmission channel WC2 may both be a wireless transmission channel with a fixed non-hopping frequency. The electronic label 20, 40, 60 transmits and receives data on a relatively low-frequency wireless transmission channel according to the time slot schedule TS, or transmits and receives data on a frequency-hopping bluetooth low energy (BLE) transmission channel according to the time slot schedule TS.

In an embodiment of the present disclosure, the use of the TDMA to transmit data between the electronic label and the base station can be combined with the frequency hopping of the bluetooth low energy protocol, which can not only avoid the problem of interference in the same frequency of the communication channel, but also can improve the confidentiality of data, because it is difficult for data thieves to crack the frequency hopping sequence and lock the frequency to steal data. It is usually a loop with no rules or 2 to the power of n; as long as n is large enough, it is equivalent to the rule of the non-sequential loop.

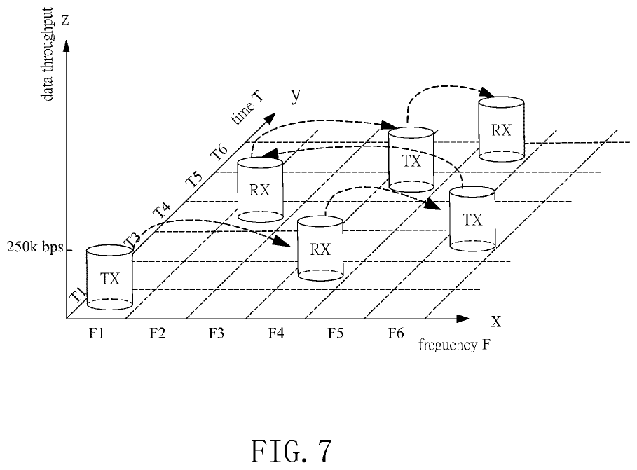

Please refer to FIG. 7, which is a schematic diagram of using the BLE protocol to transmit the data DS between the electronic label LB and the base stations BS1, BS2 according to a preferred embodiment of the present disclosure. The x-axis represents the frequency hopping frequency under the BLE protocol, the y-axis represents the data transmitting and receiving time under the BLE protocol, and the z-axis represents the data throughput under the BLE protocol, in bps. The frequency of the general WIFI is fixed, and a series of complete data are transmitted without frequency hopping during the transmission process. For example, with a central frequency of 2.4 GHz and a frequency band of 10 MHz, there can be a total of 10 communication channels. Each point-to-point transmission can use the most fast data transmission rate of 100M bps to transmit data. The channel configuration of the general bluetooth protocol uses 79 1-MHz channels. The center frequency can be 2.4 GHz, and the frequency band can be 1 MHz. There can be a total of 82 communication channels. Each point-to-point transmission can transmit data at a data transmission rate of 1˜3M bps by using the TDMA with frequency hopping. In FIG. 7, the BLE protocol is used to transmit data DS between the electronic label LB and the base stations BS1, BS2. The BLE protocol uses 40 2-MHz channels. The center frequency can be 2.4 GHz, and the frequency band can be 1 MHz. There can be any number of connection points. Each point-to-point transmission can use the TDMA with frequency hopping to transmit data at a data transmission rate of 125k˜2M bps. Table 1 comparing the general bluetooth and the BLE is as follows:

| | Classical | | | |
|---|---|---|---|---|
| | bluetooth | | | |
| Technical standard | technology | | BLE technology | |
| General distance/range | 15 | m | >15 | m |
| Air data rate | 1~3 | Mbit/s | 125 kbit/s~2 Mbit/s | |
| Data throughput | 0.7~2.1 | Mbit/s | 0.27 | Mbit/s |
| Wake up time (from the | Typical 100 ms | | 6 | ms |
| disconnected state) | | | | |
| Minimum total time for | 100 | ms | 3 | ms |
| data transmission | | | | |
| (affecting battery life) | | | | |
| Power consumption | Ref. value = 1 W | | 0.01~0.5 W | |
| | | | (depending on the | |
| | | | using condition) | |
| Peak current consumption | <30 | mA | <15 | mA |

In FIG. 7, when two frequency hopping devices try to transmit data to each other, one of the devices serves as the master device, and the other serves as the follower (Slave). For example, the gateway device GW, 30 in the present disclosure serves as the master device, and the electronic label LB serves as the follower. When both devices are powered on, they will first establish a connection using the inquiry channels, and synchronize their time. After the connection is established, both devices will start communication based on the communication channel required by the master device. Both devices need to send data to each other, and receive data from each other. For either device, it needs to transmit data in certain time slots, and in other time slots, it only waits for messages from the other device, as shown in FIG. 7. The electronic label LB uses the F1 channel to transmit data at T1. At T2, the base station BS1 uses the F4 channel to transmit data. At this time, the electronic label LB is only in the receiving state. At T3, it is the turn of the electronic label LB to transmit data, and so on. In one embodiment of the present disclosure, a button battery is used as the power source of the electronic label LB. For example, at a transmission rate of 250 k bps, the battery can last for about 7 years before it needs to be replaced.

In FIG. 7, because the frequency hopping system jumps in multiple channels of the working frequency, a malicious interferer cannot accurately interfere with the channel used at a specific time without knowing the frequency hopping sequence. The communication cannot be completely blocked, unless the entire frequency band is jammed. In addition, because the frequency hopping system hops in multiple channels of the working frequency, a malicious person can only intercept fragments of data in the same channel, but cannot intercept the complete communication content. If an encryption mechanism is added to the data itself, the difficulty of decoding is further increased, so the frequency hopping system has excellent confidentiality. Some frequency hopping systems have the ability of adaptive frequency hopping; that is, when the system transmits data through frequency hopping, and certain channels are interfered by surrounding radio waves, the system will automatically avoid the interfered channels for a period of time until the interference source is removed, and then reuse the channels.

While the disclosure has been described in terms of what is presently considered to be the most practical and preferred embodiments, it is to be understood that the disclosure need not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A system for an electronic label, comprising:
a first base station (BS) having an identifier (ID) and a first wireless transmission channel, and transmitting a first wireless signal having a first signal strength and effective in a first area;
a second BS having the ID and the first wireless transmission channel, and transmitting a second wireless signal having a second signal strength and effective in a second area;
an access point (AP) having a second wireless transmission channel configured to conduct a communication with the first BS and the second BS and allocate time slot schedules for the communication with the first BS and the second BS; and
at least one electronic label configured in at least one of the first area and the second area, wherein:
the at least one electronic label conducts transmissions on the first wireless transmission channel according to the time slot schedules; and
when the at least one electronic label moves between the first area and the second area, the at least one electronic label is configured to determine whether the at least one electronic label conducts transmission with the first BS or the second BS on the first wireless transmission channel according to which one of the first signal strength and the second signal strength is stronger.

2. The system as claimed in claim 1, wherein:
the first wireless transmission channel and the second wireless transmission channel may be the same;
the first BS and the AP are integrated into a gateway device, the gateway device has the ID and the first wireless transmission channel, and the gateway device directly communicates with the at least one electronic label in a third area and has a one-tier network architecture; and
the second area partially overlaps with the third area, and the gateway device communicates indirectly with the at least one electronic label which is located in the second area and out of the third area through the second BS, and has a two-tier network architecture.

3. The system as claimed in claim 2, wherein:
when the at least one electronic label moves between the third area and the second area, on a condition that the first signal strength is greater than the second signal strength, the at least one electronic label transmits the data to and receives the data from the gateway device; and
on a condition that the second signal strength is greater than the first signal strength, the at least one electronic label conducts transmission with the second BS.

4. The system as claimed in claim 1, wherein:
the electronic label is an electronic shelf label (ESL);
on a condition that the first signal strength is greater than the second signal strength, the at least one electronic label conducts transmission with the first BS on the first wireless transmission channel;
on a condition that the second signal strength is greater than the first signal strength, the at least one electronic label conducts transmission with the second BS on the first wireless transmission channel; and
on a condition that the first signal strength equals to the second signal strength, the at least one electronic label conducts transmission with an original BS on the first wireless transmission channel, wherein the original BS is one of the first BS and the second BS.

5. The system claimed in claim 1, wherein:
the identifier is a service set identifier (SSID);
the first BS and the second BS each is one of a router and a wireless IP sharing device;
the first area partially overlaps with the second area; and
the first and second wireless transmission channels each is a relatively low-frequency wireless transmission channel.

6. The system as claimed in claim 1, wherein an allowable number of the at least one electronic label for each of the first BS and the second BS is proportional to a total number of time slots associated with the corresponding time slot schedule received by each of the first BS and the second BS.

7. The system as claimed in claim 1, wherein the first wireless transmission channel and the second wireless transmission channel each is a wireless transmission channel with a fixed non-hopping frequency.

8. The system as claimed in claim 1, wherein the at least one electronic label transmits and receives data on a transmission channel having a frequency-hopping Bluetooth Low Energy (BLE) according to the time slot schedule.

9. A method for an electronic label, comprising the following steps:
providing at least one electronic label, a first base station (BS), a second BS and an access point (AP), wherein the first BS has an identifier (ID) and a first wireless transmission channel, the first BS transmits a first wireless signal having the first signal strength and effective in a first area, the second BS has the ID and the first wireless transmission channel and transmits a second wireless signal having the second signal strength and effective in a second area, the AP has a second wireless transmission channel to communicate with the first and the second BSs to allocate time slot schedules to the first BS and the second BS, and the at least one electronic label is configured in at least one of the first area and the second area;
receiving the first wireless signal from the first BS during a first time period, and receiving the second wireless signal from the second BS during a second time period;
determining whether the at least one electronic label conducts transmission with the first BS or the second BS on the first wireless transmission channel according to which one of the first signal strength and the second signal strength is stronger; and
receiving a time slot schedule from at least one of the first BS and the second BS, wherein according to the time slot schedule, the at least one electronic label conducts transmission with the first or second BS on the first wireless transmission channel.

10. The method as claimed in claim 9, wherein:
the first wireless transmission channel and the second wireless transmission channel may be the same;
the first BS and the AP are integrated into a gateway device, the gateway device has the ID and the first wireless transmission channel, and the gateway device directly communicates with the at least one electronic label in a third area and has a one-tier network architecture; and
the second area partially overlaps with the third area, and the gateway device communicates indirectly with the at least one electronic label which is located in the second area and out of the third area through the second BS, and has a two-tier network architecture.

11. The method as claimed in claim 9, further comprising steps of:
when the at least one electronic label moves between the third area and the second area, on a condition that the first signal strength is greater than the second signal strength, the at least one electronic label conducts transmission with the gateway device; and
on a condition that the second signal strength is greater than the first signal strength, the at least one electronic label conducts transmission with the second BS.

12. The method as claimed in claim 9, further comprising steps of:
on a condition that the first signal strength is greater than the second signal strength, the at least one electronic label conducts transmission with the first BS on the first wireless transmission channel;
on a condition that the second signal strength is greater than the first signal strength, the at least one electronic label conducts transmission with the second BS on the first wireless transmission channel; and
on a condition that the first signal strength equals to the second signal strength, the at least one electronic label conducts transmission with an original BS on the first wireless transmission channel, wherein the original BS is one of the first BS and the second BS.

13. The method as claimed in claim 9, wherein an allowable number of the at least one electronic label for each of the first BS and the second BS is proportional to a total number of time slots associated with the corresponding time slot schedule received by either of the first BS and the second BS.

14. The method as claimed in claim 9, wherein the first wireless transmission channel and the second wireless transmission channel each is a wireless transmission channel with a fixed non-hopping frequency.

15. The method as claimed in claim 9, wherein the at least one electronic label transmits and receives data on a transmission channel having a frequency-hopping Bluetooth Low Energy (BLE) according to the time slot schedule.

16. A gateway device using a wireless transmission channel and an identifier (ID), comprising:
a first transceiver module configured to transmit a first wireless signal to and receive an indication from one of an electronic label and a base station; and
a first processing module electrically connected to the first transceiver module, and configured to determine whether to communicate with one of the electronic label and the base station on the wireless transmission channel according to the indication, wherein after determining that the first processing module communicates with the electronic label on the wireless transmission channel, the gateway device transmits a time slot schedule to one of the electronic label and the BS, so that the electronic label or the BS transmits a data to the gateway device on the wireless transmission channel according to the time slot schedule.

17. The gateway device as claimed in claim 16, wherein:
the gateway device includes the first BS and an access point (AP);
the first BS and the AP have the ID and the wireless transmission channel, the first wireless signal of the gateway device is effective in a first area, and the gateway device communicates directly with the electronic label in the first area, and has a one-tier network architecture;
the gateway device communicates with a second BS configured to transmit a second wireless signal on the wireless transmission channel, the second wireless signal is effective in a second area, the first area partially overlaps with the second area, and the gateway device communicates indirectly with the electronic label which is located in the second area and out of the first area through the second BS, and has a two-tier network architecture.

18. The gateway device as claimed in claim 16, wherein:
the indication of the electronic label is associated with communication quality-related parameters between the gateway device and the electronic label;
the communication quality-related parameters include a received signal strength indicator (RSSI);
the electronic label is an electronic shelf label (ESL); and
the information is an ESL-related information.

19. The gateway device as claimed in claim 17, wherein:
the electronic label and the second BS use the same wireless transmission channel, and the electronic label includes:
a second transceiver module configured to receive a first signal having a first signal strength from the first BS during a first period, and configured to receive a second signal having a second signal strength from the second BS during a second period; and
a second processing module electrically connected to the second transceiver module, and configured to determine which of the first and the second BSs should communicate with the electronic label on the wireless transmission channel according to which one of the first signal strength and the second signal strength is stronger.

20. The gateway device as claimed in claim 17, wherein:
the first wireless signal is effective in a first area, the second wireless signal is effective in a second area, and the first area partially overlaps with the second area;
on a condition that the first signal strength is greater than a second signal strength, the electronic label conducts transmission with the first BS on the first wireless transmission channel;
on a condition that the second signal strength is greater than the first signal strength, the electronic label conducts transmission with the second BS on the first wireless transmission channel;
on a condition that the first signal strength is equal to the second signal strength, the electronic label maintains transmission with an original BS on the first wireless transmission channel, wherein the original BS is one of the first BS and the second BS;
the first BS and the second BS communicate with an access point (AP) on a second wireless transmission channel; and
the first wireless transmission channel and the second wireless transmission channel may be the same.
